(19) United States
(12) Patent Application Publication
(10) Pub. No.: US 2006/0080515 A1
(43) Pub. Date: Apr. 13, 2006

(54) Non-Volatile Memory Backup for Network Storage System

(75) Inventors: John Spiers, Louisville, CO (US); Mark Loffredo, Libertyville, IL (US); Mark G. Hayden, Fairfield, CA (US); Mike A. Hayward, Boulder, CO (US)

Correspondence Address: KENNETH C. WINTERTON;HOLLAND & HART LLP, P. O. BOX 8749, DENVER, CO, 80201-8749, US

(73) Assignee: LEFTHAND NETWORKS, INC., Boulder, CO (US)

(21) Appl. No.: 10/711,901

(22) Filed: Oct. 12, 2004

(51) Int. Cl. G06F 12/00

(52) U.S. Cl. 711/162; 714/14

(57) ABSTRACT

A data storage system including a primary data storage device and a backup data storage device stores data with enhanced performance. The primary data storage device has a primary data storage device memory for holding data, and the backup data storage device has a backup volatile memory, a backup non-volatile memory, and a processor. The backup storage device processor causes a copy of data provided to the primary data storage device to be provided to the backup data storage device volatile memory, and in the event of a power interruption moves the data from the backup volatile memory to the backup non-volatile memory. In such a manner, data stored at the backup data storage device is not lost in the event of a power interruption. The backup data storage device further includes a backup power source such as a capacitor, a battery, or any other suitable power source, and upon detection of a power interruption, switches to the backup power source and receives power from the backup power source while moving the data from the backup volatile memory to the backup non-volatile memory.

### FIELD OF THE INVENTION

The present invention relates to non-volatile data backup in a storage system, and, more specifically, to a data backup device utilizing volatile memory and non-volatile memory.

### BACKGROUND OF THE INVENTION

Data storage systems are used in numerous applications and have widely varying complexity related to the application storing the data, the amount of data required to be stored, and numerous other factors. A common requirement is that the data storage system securely store data, meaning that stored data will not be lost in the event of a power loss or other failure of the storage system. In fact, many applications store data at primary data storage systems and this data is then backed-up, or archived, at predetermined time intervals in order to provide additional levels of data security.

In many applications, a key measure of performance is the amount of time the storage system takes to store data sent to it from a host computer. Generally, when storing data, a host computer will send a write command, including data to be written, to the storage system. The storage system will store the data and report to the host computer that the data has been stored. The host computer generally keeps the write command open, or in a “pending” state, until the storage system reports that the data has been stored, at which point the host computer will close the write command. This is done so that the host computer retains the data to be written until the storage system has stored the data. In this manner, data is kept secure and in the event of an error in the storage system, the host computer retains the data and may attempt to issue another write command.

When a host computer issues a write command, overhead within the computer is consumed while waiting for the storage system to report that the write is complete. This is because the host computer dedicates a portion of memory to the data being stored, and because the host computer uses computing resources to monitor the write command. The amount of time required for the storage system to write data depends on a number of factors, including the amount of read/write operations pending when the write command was received, and the latency of the storage devices used by the storage system. Some applications utilize methods of reducing the amount of time required for the storage system to report that the write command is complete, such as, for example, utilizing a write back cache which reports that a write command is complete before that data is written to the media in the storage system. While this increases the performance of the storage system, if there is a failure within the storage system prior to the data being written to the media, the data may be lost.

### SUMMARY OF THE INVENTION

The present invention has recognized that a significant amount of resources may be consumed in performing write operations to write data to a data storage device within a data storage system. The resources consumed in such operations may be computing resources associated with a host computer, or other applications, which utilize the data storage system to store data. Computing resources associated with the host computer may be underutilized when the host computer is waiting to receive an acknowledgment that the data has been written to the storage device. This wait time is a result of the speed and efficiency with which the data storage system stores data.

The present invention increases resource utilization when storing data at a storage system by reducing the amount of time a host computer waits to receive an acknowledgment that data has been stored by increasing the speed and efficiency of data storage in a data storage system. Consequently, in a computing system utilizing the present invention, host computing resources are preserved, thus enhancing the efficiency of the computing system.

In one embodiment, the present invention provides a data storage system comprising (a) a first data storage device including a first data storage device memory for holding data, (b) a second data storage device including (i) a second data storage device volatile memory, (ii) a second data storage device non-volatile memory, and (iii) a processor for causing a copy of data provided to the first data storage device to be provided to the second data storage device volatile memory, and in the event of a power interruption moving the data from the second data storage device volatile memory to the second data storage device non-volatile memory. In such a manner, data stored at the second data storage device is not lost in the event of a power interruption.

The first data storage device, in an embodiment comprises at least one hard disk drive having an enabled volatile write-back cache and a storage media capable storing data. The first data storage device may, upon receiving data to be stored on the storage media, store the data in the volatile write-back cache and generate an indication that the data has been stored before storing the data on the media. The first data storage device may also include a processor executing operations to modify the order in which the data is stored on the media after the data is stored in the write-back cache. In the event of a power interruption, data in the write-back cache may be lost, however, a copy of the data will continue to be available at the second data storage device, thus data is not lost in such a situation.

In an embodiment, the second data storage device further comprises a secondary power source. The secondary power source may comprise a capacitor, a battery, or any other suitable power source. The second data storage device, upon detection of a power interruption, switches to the secondary power source and receives power from the secondary power source while moving the data from the second data storage device volatile memory to the second data storage device non-volatile memory. Upon completion of moving the data from the second data storage device volatile memory to the second data storage device non-volatile memory, the second data storage device shuts down, thus preserving the secondary power source.

In one embodiment, the second data storage device non-volatile memory comprises an electrically erasable programmable read-only-memory, or a flash memory. The second data storage device volatile memory may be a random access memory, such as a SDRAM. In this embodiment, upon detection of a power interruption, the processor reads the data from the second data storage device volatile memory, writes the data to the second data storage device non-volatile memory, and verifies that the data stored in the second data storage device non-volatile memory is correct. The processor may verify that the data stored in the second data storage device non-volatile memory is correct by comparing the data from the second data storage device non-volatile memory with the data from the second data storage device volatile memory, and re-writing the data to the second data storage device non-volatile memory when the comparison indicates that the data is not the same. In another embodiment, the processor, upon detection of a power interruption, reads the data from the second data storage device volatile memory, computes an ECC for the data, and writes the data and ECC to the second data storage device non-volatile memory.

In a further embodiment, the first data storage device and second data storage device are operably interconnected to a storage server. The storage server is operable to cause data to be provided to each of the first and second data storage devices. The storage server may comprise an operating system, a CPU, and a disk I/O controller. The storage server, in an embodiment, (a) receives block data to be written to the first data storage device, the block data comprising unique block addresses within the first data storage device and data to be stored at the unique block addresses, (b) stores the block data in the second data storage device, (c) manipulates the block data, based on the unique block addresses, to enhance the efficiency of the first data storage device when the first data storage device stores the block data to the first data storage device memory, and (d) issues one or more write commands to the first data storage device to write the block data to the first data storage device memory. Manipulating the block data may include reordering the block data based on the unique block addresses such that seek time within the first data storage device is reduced.

Another embodiment of the invention provides a method for storing data in a data storage system. The method comprising: (a) providing a first data storage device comprising a first memory for holding data; (b) providing a second data storage device comprising a second volatile memory and a second non-volatile memory; (c) storing data to be stored at the first data storage device at the second data storage device in the second volatile memory; and (d) moving the data from the second volatile memory to the second non-volatile memory in the event of a power interruption. The first data storage device may comprise at least one hard disk drive having a volatile write-back cache and a storage media capable storing the data. The first data storage device, upon receiving data to be stored on the storage media, stores the data in the volatile write-back cache and generates an indication that the data has been stored at the first data storage device before storing the data on the media.

In one embodiment, the second data storage device further comprises a secondary power source. The secondary power source may comprise a capacitor, a battery, or other suitable power source. In this embodiment, the moving step comprises: (a) switching the second memory device to the secondary power source; (b) reading the data from the second data storage device volatile memory; and (c) writing the data to the second data storage device non-volatile memory. In another embodiment, the moving step further comprises: (d) switching the second memory device off following the writing step. The moving step comprises, in another embodiment: (a) detecting a power interruption; (b) reading the data from the second data storage device volatile memory; (c) computing an ECC for the data; and (d) writing the data and ECC to the second data storage device non-volatile memory.

In another embodiment, the moving step comprises: (a) detecting a power interruption; (b) reading the data from the second data storage device volatile memory; (c) writing the data to the second data storage device non-volatile memory; and (d) verifying that the data stored in the second data storage device non-volatile memory is correct. The verifying step comprises, in an embodiment: (i) comparing the data from the second data storage device non-volatile memory with the data from the second data storage device volatile memory; and (ii) re-writing the data to the second data storage device non-volatile memory when the comparing step indicates that the data is not the same.

### BRIEF DESCRIPTION OF THE DRAWINGS

FIG. 1 is a block diagram illustration of a network having applications and network attached storage;

FIG. 2 is a block diagram illustration of a data storage system of an embodiment of the present invention;

FIG. 3 is a block diagram illustration of a data storage system of another embodiment of the present invention;

FIG. 4 is a block diagram illustration of a backup device of an embodiment of the present invention;

FIG. 5 is a block diagram illustration of a PCI backup device of an embodiment of the present invention;

FIG. 6 is a flow chart diagram illustrating the operational steps performed by a storage controller of an embodiment of the present invention;

FIG. 7 is a flow chart diagram illustrating the operational steps performed by a backup device processor following the power on of the backup device of an embodiment of the present invention;

FIG. 8 is a flow chart diagram illustrating the operational steps performed by a backup device processor following a reset of the backup device of an embodiment of the present invention;

FIG. 9 is a flow chart diagram illustrating the operational steps performed by a backup device processor when receiving commands, for an embodiment of the present invention;

FIG. 10 is a flow chart diagram illustrating the operational steps performed by a backup device processor when transferring data from host memory to SDRAM, for an embodiment of the present invention;

FIG. 11 is a flow chart diagram illustrating the operational steps performed by a backup device processor when transferring data from SDRAM to host memory, for an embodiment of the present invention;

FIG. 12 is a flow chart diagram illustrating the operational steps performed by a backup device processor when transferring data from SDRAM to NVRAM, for an embodiment of the present invention;

FIG. 13 is a flow chart diagram illustrating the operational steps performed by a backup device processor when transferring data from NVRAM to SDRAM, for an embodiment of the present invention; and

FIG. 14 is a flow chart diagram illustrating the operational steps performed by a backup device processor when a power failure is detected, for an embodiment of the present invention.

### DETAILED DESCRIPTION

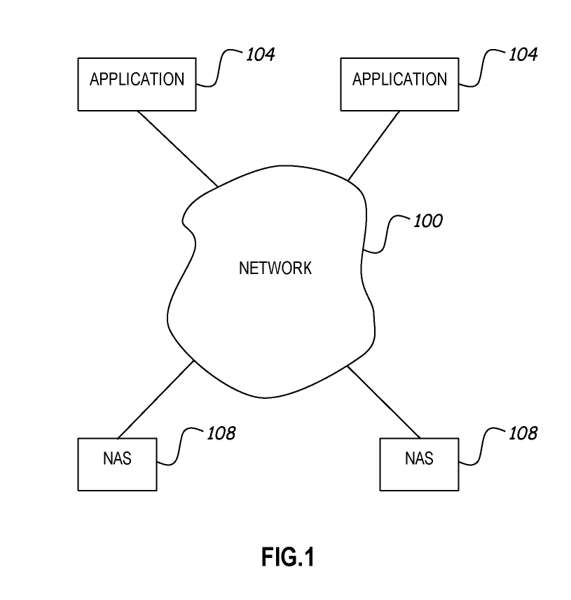

Referring to FIG. 1, a block diagram illustration of a computing network and associated devices, of an embodiment of the present invention. In this embodiment, a network 100 has various connections to applications 104 and network attached storage (NAS) devices 108. The network 100, as will be understood, may be any computing network utilized for communications between attached network devices, and may include, for example, a distributed network, a local area network, and a wide area network, to name but a few. The applications 104 may be any of a number of computing applications connected to the network, and may include, for example, a database application, an email server application, an enterprise resource planning application, a personal computer, and a network server application, to name but a few. The NAS devices 108 are utilized in this embodiment for storage of data provided by the applications 104. Such network attached storage is utilized to store data from one application, and make the data available to the same application, or another application. Furthermore, such NAS devices 108 may provide a relatively large amount of data storage, and also provide data storage that may be backed up, mirrored, or otherwise secured such that loss of data is unlikely. Utilizing such NAS devices 108 can reduce the requirements of individual applications requiring such measures to prevent data loss, and by storing data at one or more NAS devices 108, data may be securely retained with a reduced cost for the applications 104. Furthermore, such NAS devices 108 may provide increased performance relative to, for example, local storage of data. This improved performance may result from relatively high speed at which the NAS devices 108 may store data.

A key performance measurement of NAS devices 108 is the rate at which data may be written to the devices and the rate at which data may be read from the devices. In one embodiment, the NAS devices 108 of the present invention receive data from applications 104, and acknowledge back to the application 104 that the data is securely stored at the NAS device 108, before the data is actually stored on storage media located within the NAS 108. In this embodiment, the performance of the NAS is increased, because there is no requirement for the NAS device to wait for the data to be stored at storage media. For example, one or more hard disk drives may be utilized in the NAS 108, with the NAS reporting to the application 104 that a data write is complete before the data is stored on storage media within the hard disk drive(s). In order to provide security to the data before it is stored on storage media, the NAS devices 108, of this embodiment, store the data in a non-volatile memory, such that if a power failure, or other failure, occurs prior to writing the data to the storage media, the data may still be recovered.

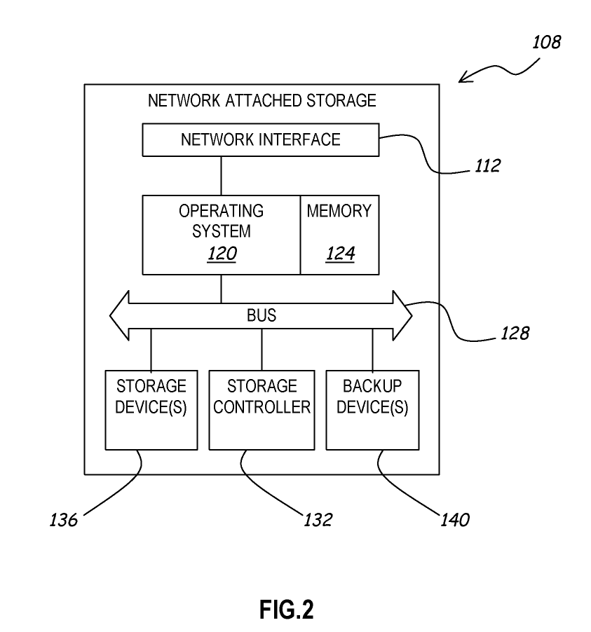

Referring now to FIG. 2, a block diagram illustration of a NAS device 108 of an embodiment of the present invention is now described. In this embodiment, the NAS 108 includes a network interface 112, which provides an appropriate physical connection to the network and operates as an interface between the network 100 and the NAS device 108. The network interface 112 may provide any available physical connection to the network 100, including optical fiber, coaxial cable, and twisted pair, to name but a few. The network interface 112 may also operate to send and receive data over the network 100 using any of a number of transmission protocols, such as, for example, iSCSI and Fibre Channel. The NAS 108 includes an operating system 120, with an associated memory 124. The operating system 120 controls operations for the NAS device 108, including the communications over the network interface 112. The NAS device 108 includes a data communication bus 128 that, in one embodiment, is a PCI bus. The NAS device 108 also includes a storage controller 132 that is coupled to the bus 128. The storage controller 132, in this embodiment, controls the operations for the storage and retrieval of data stored at the data storage components of the NAS device 108. The NAS device 108 includes one or more storage devices 140, which are utilized to store data. In one embodiment, the storage devices 140 include a number of hard disk drives. It will be understood that the storage device(s) 140 could be any type of data storage device, including storage devices that store data on storage media, such as magnetic media, tape media, and optical media. The storage devices may also include solid-state storage devices that store data in electronic components within the storage device. In one embodiment, as mentioned, the storage device(s) 140 comprise a number of hard disk drives. In another embodiment, the storage device(s) 140 comprise a number of hard disk drives configured in a RAID configuration. The NAS device 108 also includes one or more backup devices 144 connected to the bus 128. In the embodiment of FIG. 2, the NAS device 108 includes one backup device 144, having a non-volatile memory, in which the storage controller 132 causes a copy of data to be stored at storage devices 140 to be provided to the backup device 144 in order to help prevent data loss in the event of a power interruption or other failure within the NAS device 108. In other embodiments, more than one backup device 144 may be utilized in the NAS device 108.

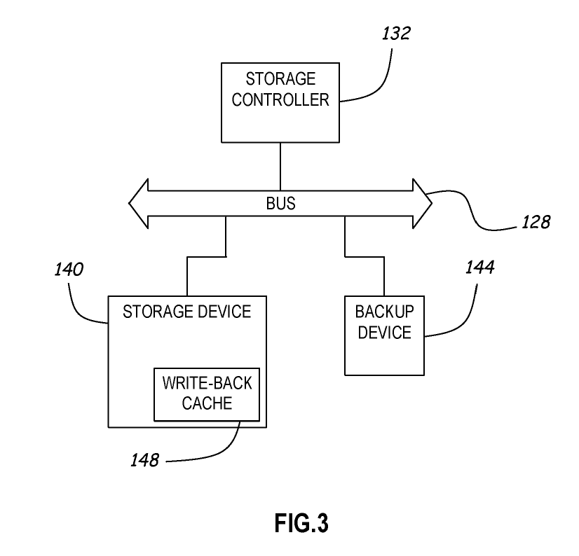

Referring now to FIG. 3, a storage controller 132, storage device 140, and backup memory 144 of an embodiment are described in more detail. In this embodiment, the storage device 140 is a hard disk drive having an enabled write-back cache 148. It will be understood that the storage device 140 may comprise a number of hard disk drives, and/or one or more other storage devices, and that the embodiment of FIG. 3 is described with a single hard disk drive for the purposes of discussion and illustration only. The principles and concepts as described with respect to FIG. 3 fully apply to other systems having more or other types of storage devices. As mentioned, the storage device 140 includes an enabled write-back cache 148. A write-back cache 140 is utilized in this embodiment to store data written to the storage device 140 before the data is actually written to the media within the storage device 140. When the data is stored in the write-back cache 148, the storage device 140 acknowledges that the data has been stored. By utilizing the write-back cache 148, the storage device 140 in most cases has significantly improved performance relative to the performance of a storage device that does not have an enabled write-back cache.

As is understood, storage devices may utilize a write-back cache to enhance performance by reducing the time related to the latency within the storage device. For example, in a hard disk drive, prior to writing data to the storage media, the drive must first position the read/write head at the physical location on the media where the data is to be stored, referred to as a seek. Seek operations move an actuator arm having the read/write head located thereon to a target data track on the media. Once the read/write head is positioned at the proper track, it then waits for the particular portion of the media where the data is to be stored to rotate into position where data may then be read or written. The time required to position the actuator arm and wait for the media to move into the location where data may be read or written depends upon a number of factors, and is largely dependent upon the location of the actuator arm prior to moving it to the target track. In order to reduce seek times for write operations, a disk drive may evaluate data stored in the write-back cache 148, and select data to be written which requires a reduced seek time compared to other data in the write-back cache, taking into consideration the current location of the read/write head on the storage media. The data within the write-back cache may thus be written to the media in a different order than received, in order to reduce this seek time and enhance the performance of the storage device.

A disadvantage of using such a cache is that, if the storage device 140 loses power or has another failure that prevents the data from being written to the storage media, the data in the write-back cache 148 may be lost. Furthermore, because the storage device 140 reported that the write was complete, the entity writing the data to the storage device 140 is not aware that the data has been lost, or what data has been lost. In the embodiment of FIG. 3, the storage controller 132 stores a copy of the data in the backup device 144 as well as writing the data to the storage device 140. In this embodiment, if a failure occurs which results in the storage device 140 not storing the data to the storage media, a copy of the data is maintained in the backup device 144. In one embodiment, as will be discussed in more detail below, the backup device 144 includes a volatile memory, and a non-volatile memory into which data is moved in the event of a power failure. In this manner, the storage device 140 write-back cache 148 may be enabled while having a high degree of certainty that data will not be lost in the event of a failure in the storage device 140. In one embodiment, the storage controller 132 periodically flushes the data stored in the backup device 144 by verifying that the data is stored on the media within the storage device 140 and enabling the removal of the data from the backup device 144.

In another embodiment, in order to further enhance the efficiency of the storage device 140 when performing seek operations, the operating system 120 also comprises a memory 124, as illustrated in FIG. 2, and is able to cache data and analyze the target location of the cached data on the physical media of the storage device 140. In this embodiment, the NAS device 108 receives blocks of data to be written to the storage device 140. The blocks of data contain information that may be utilized to determine the physical location on the storage device media where the data is to be stored. This information is evaluated and the order in which the blocks of data are written to the storage device 140 may be modified in order to reduce the physical distance between locations where data from successive writes will be stored on the physical media. In this embodiment, the operating system 120 causes a copy of the data to be stored at the backup device 144, such that if a failure occurs in which the memory 124 may lose the data, the data will be secure at the backup device 144.

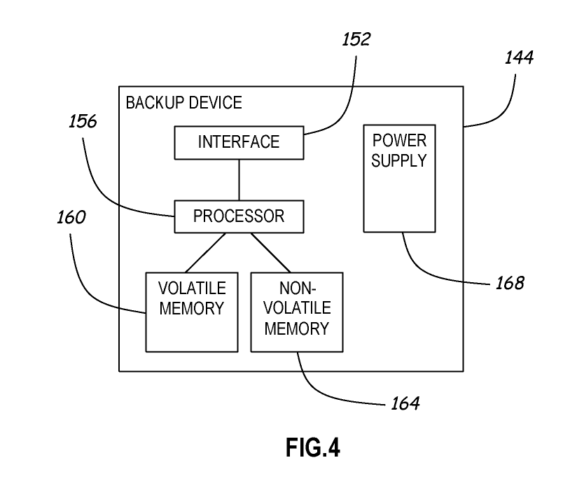

Referring now to FIG. 4, a block diagram illustration of a backup device 144 of an embodiment is now described. In this embodiment, the backup device comprises an interface 152, a backup device processor 156, a volatile memory 160, a non-volatile memory 164, and a power supply 168. The interface 152 may be any type of interface and is utilized to communicate with the storage controller 132. The interface 152 is connected to the processor 156, which controls operations within the backup device 144. Connected to the processor 156 are the volatile memory 160 and the non-volatile memory 164. The volatile memory 160, in one embodiment, is SDRAM utilized to store data from the storage controller 132 during typical write operations. The non-volatile memory 164, in one embodiment, is flash memory, and is utilized in the event of a power failure detection. As is understood, flash memory is a type of nonvolatile memory that may be erased and reprogrammed in units of memory referred to as blocks or pages. The processor 156, in this embodiment, upon detecting a power failure, switches the backup device 144 to the power supply 168, and moves the data in the volatile memory 160 to the non-volatile memory 164. After the data from the volatile memory 160 is stored in the non-volatile memory 164, the processor 156 shuts down the backup device 144. The power supply 168, in one embodiment, includes one or more capacitors that are charged when the backup device 144 is powered up. In the event of a power interruption, the backup device 144 receives power from the capacitor(s) when moving the data. After the data is securely stored in the non-volatile memory 164, the power is switched off from the capacitor(s). In another embodiment, the power supply 168 includes one or more batteries. As will be understood, any type of power supply 168 may be utilized, so long as power may be supplied to the backup device 144 for a sufficient time period to move the data to the non-volatile memory 164.

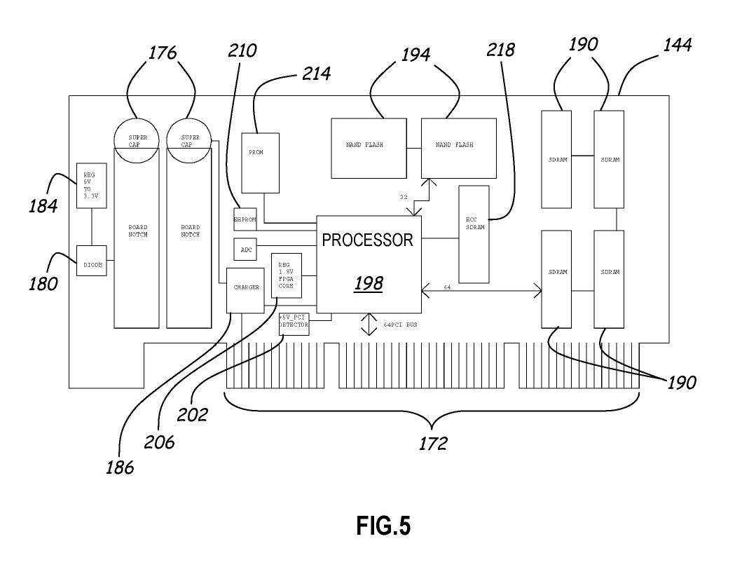

Referring now to FIG. 5, a block diagram illustration of a backup device of one embodiment is now described. In this embodiment, the backup device is embodied in a PCI card having a 64-bit PCI connector 172. The power supply comprises two super capacitors 176, which, in this embodiment, are 50 F each and connected in parallel. The capacitors 176 are connected to a diode 180 a voltage regulator 184, and a charger 186. The charger 186 is utilized to charge the capacitors 176, and in the event of a power failure the capacitors are used as the power source to power the backup device 144 when moving data from the volatile memory to the non-volatile memory. In the embodiment of FIG. 5, the volatile memory comprises a number of SDRAM modules 190. The non-volatile memory in this embodiment comprises a number of NAND flash modules 194. A FPGA processor 198 that provides PCI interfacing through a 64-bit PCI bus, is connected to the SDRAM modules 190 through a 64-bit bus, and is connected to the NAND flash modules 194 through a 32-bit bus. The FPGA processor 198 utilizes a power detection circuit that, in this embodiment, is a +5V PCI detector 202. The FPGA processor receives power through a voltage regulator 206, which regulates the voltage required for the FPGA core.

An EEPROM 210 is connected to the FPGA processor 198, and is utilized to store various status indicators and counters, which may be utilized during operations. For example, if the backup device 144 restarts following a power failure, the EEPROM indicates that data is stored in the non-volatile memory of the NAND flash modules 194. Similarly, if the backup device encountered errors that resulted in an aborted attempt to move data from the SDRAM to the NAND flash following a power failure, the EEPROM would indicate that the NVRAM is not valid. The backup device 144 of this embodiment also includes a programmable read only memory (PROM) 214, housing the operating instructions for the processor 198. The backup device 144 also includes an ECC SDRAM module 218, which is utilized in determining ECC information for the backup device 144 when moving data from the SDRAM modules 190 to the NAND flash modules 194.

In an embodiment, the backup device 144 utilizes a descriptor pointer queue contained within the FPGA processor 198 to receive commands from the storage controller. In this embodiment, the descriptor pointer queue is a FIFO queue that receives pointers to descriptor chains that the FPGA processor 198 reads. The pointers, in an embodiment, are 64 bits in length, and contain commands for the processor to perform various functions. The FPGA processor 198 also includes local RAM memory, which may be utilized for data FIFOs when moving data between various components.

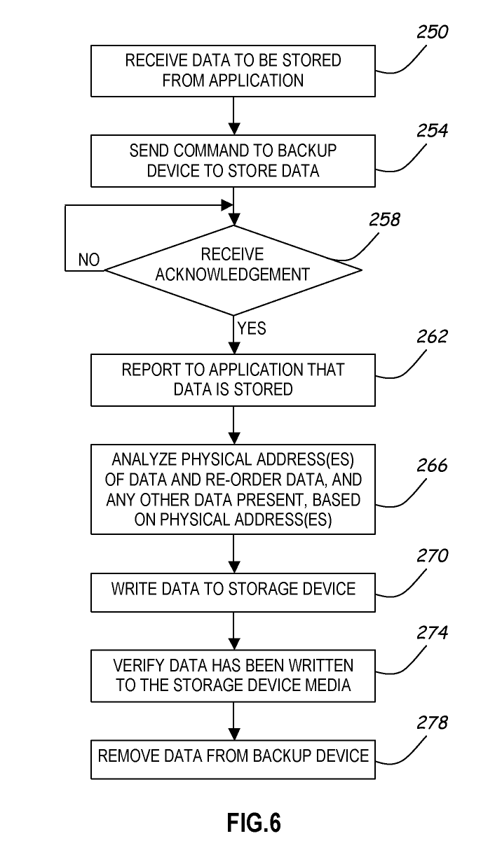

Referring now to the flow chart diagram of FIG. 6, the operational steps performed by a NAS device of an embodiment of the present invention are now described. In this embodiment, the NAS device receives data to be stored from an application, as noted at block 250. At block 254, the NAS device sends a command to the backup device to store the data. The NAS device, at block 258, determines if the backup device has acknowledged that the data is stored. Following the acknowledgment that the data is stored, the NAS device reports to the application that the data is stored, as indicated at block 262. The NAS device, at block 266, analyzes the physical address(es) within the storage media where the data is to be stored, and re-orders the data, along with any other data present, based on the physical addresses. At block 270, the NAS device writes the data to the storage device. At block 274, the NAS device verifies that the data has been written to the storage device media. Following the verification that the data has been written to the storage device media, the NAS device, at block 278, removes the data from the backup device. Accordingly, the efficiency of the storage device is enhanced by receiving write commands that contain data that is ordered such that the performance of the storage device is enhanced. In the event of a power failure, or another failure event, the NAS device may recover data from the backup device that was not written to the storage device. As will be understood, the order of the operational steps described with respect to FIG. 6 may be modified, and the order described is one example of the operational steps. Furthermore, one or more operational steps may be combined, and operations described may be broken into several operational steps.

Following the restoration of power after a power failure, power interruption, or other failure that resulted in the backup device storing data in the non-volatile memory, the data may be recovered from the backup device and written to the storage devices associated with the system. In the embodiment as described with respect to FIG. 2, the data may be written to the data storage devices 140. In one embodiment, the storage devices 140 include a plurality of hard disk drives. In one embodiment, the operating system causes an identification uniquely identifying the backup device to each of the plurality of hard disk drives. When recovering from the failure, the presence of the identification is checked for each of the hard disk drives. If the identification is present on each of the hard disk drives, the data from the backup device may be written to the drives. If the identification is not present on one or more of the hard disk drives, this indicates that one or more of the drives may have been replaced or that the data on the drive has been changed. In such a situation, data from the backup device is not written to the hard disk drives, because the data may have been changed on the drives. The operating system, in one embodiment, generates an error in such a situation, and a user may intervene and take appropriate actions to recover data, such as by, for example, rebuilding a drive from a RAID array that has been replaced. Following the rebuilding of the RAID drive, the drive is marked with the identification, and data from the backup device may be restored to the drives.

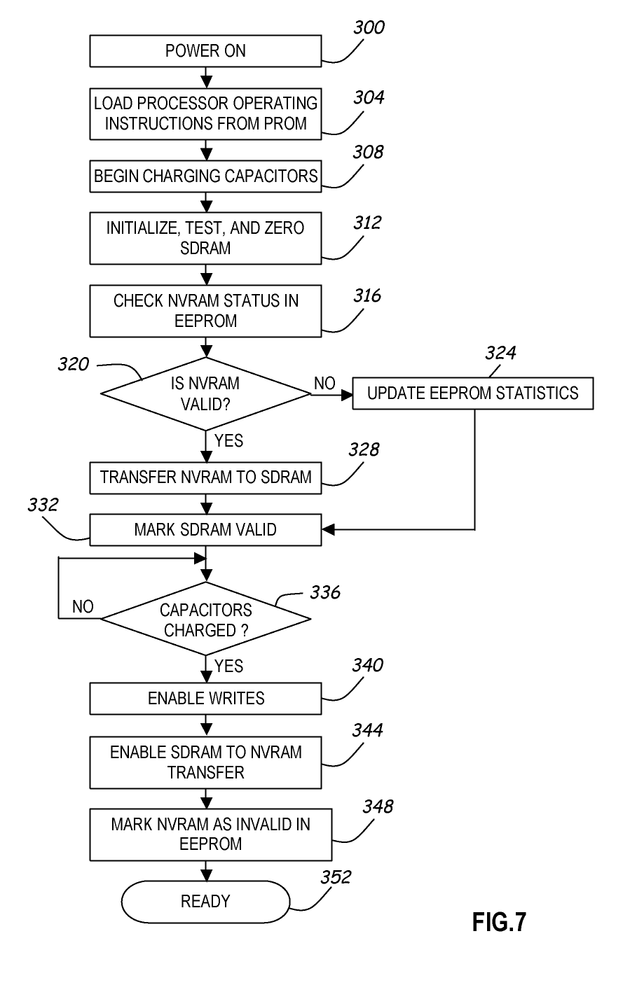

Referring now to FIG. 7, the operational steps performed by the backup device when power is applied to the device are now described. In this embodiment, power is applied to the backup device at block 300. At block 304, the processor loads operating instructions from a PROM. The operating instructions, as will be understood, may be loaded from any suitable source, including the PROM utilized in this embodiment, and may also be hard-coded into an FPGA processor. At block 308, the backup device begins charging the capacitors. The backup device processor, at block 312, initialized, tests, and zeros the SDRAM. At block 316, the NVRAM status in the EEPROM is checked. As mentioned above, in one embodiment the backup device includes an EEPROM that contains various status indicators as well as other statistics. At block 320, it is determined if the NVRAM is valid. This determination is made, in an embodiment, by checking the EEPROM to determine the status of the NVRAM. If the NVRAM is valid, as indicated by a predetermined flag status in the EEPROM, this indicates that data has been stored in the NVRAM modules. If the NVRAM is not valid, as determined at block 320, the backup device processor updates the EEPROM statistics, as indicated at block 324. If it is determined at block 320 that the NVRAM is valid, the backup device processor transfers the NVRAM to the SDRAM, as noted at block 328. At block 332, the SDRAM is marked as valid. The backup device processor determines, at block 336, if the capacitors are charged. If the capacitors are not charged, the backup device processor continues to monitor the capacitors until charged. Once the capacitors are charged, the backup device processor, as indicated at block 340, enables writes. At block 344, the backup device processor enables SDRAM to NVRAM transfer. As block 348, the NVRAM is marked as invalid in the EEPROM. At block 352, the backup device is ready. As will be understood, the order of the operational steps described with respect to FIG. 7 may be modified, and the order described is one example of the operational steps. Furthermore, one or more operational steps may be combined, and operations described may be broken into several operational steps.

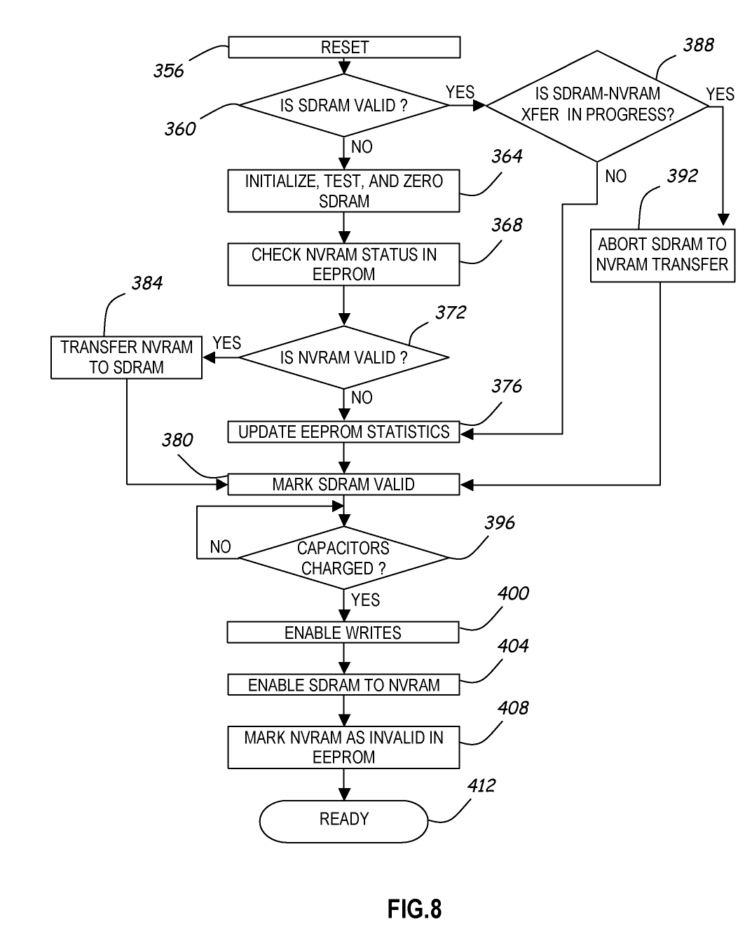

Referring now to FIG. 8, the operational steps performed by the backup device processor when the device is reset are now described. In this embodiment, the backup device is reset at block 356. At block 360, it is determined if the SDRAM is valid. If the SDRAM is not valid the backup device processor, at block 364, initializes, tests, and zeros the SDRAM. At block 368, the NVRAM status in the EEPROM is checked. At block 372, it is determined if the NVRAM is valid. This determination is made, in an embodiment, by checking the EEPROM to determine the status of the NVRAM. If the NVRAM is valid, as indicated by a predetermined flag status in the EEPROM, this indicates that data has been stored in the NVRAM modules. If the NVRAM is not valid, as determined at block 372, the backup device processor updates the EEPROM statistics, as indicated at block 376. If it is determined at block 372 that the NVRAM is valid, the backup device processor transfers the NVRAM to the SDRAM, as noted at block 384. At block 380, the SDRAM is marked as valid. If, at block 360, it is determined that the SDRAM is valid, it is then determined if a SDRAM to NVRAM transfer was in progress at the time the backup device was reset, as indicated at block 388. If a SDRAM to NVRAM transfer was not in progress, the backup device processor performs the operational steps as described with respect to block 376. If a SDRAM to NVRAM transfer was in progress, as determined at block 388, the backup device processor aborts the SDRAM to NVRAM transfer, according to block 392. Following aborting the SDRAM to NVRAM transfer at block 392, the operational steps as described with respect to block 380 are performed. At block 396, the backup device processor determines if the capacitors are charged. If the capacitors are not charged, the backup device processor continues to monitor the capacitors until charged. Once the capacitors are charged, the backup device processor, as indicated at block 400, enables writes. At block 404, the backup device processor enables SDRAM to NVRAM transfer. At block 408, the NVRAM is marked as invalid in the EEPROM. At block 412, the backup device is ready. As will be understood, the order of the operational steps described with respect to FIG. 8 may be modified, and the order described is one example of the operational steps. Furthermore, one or more operational steps may be combined, and operations described may be broken into several operational steps.

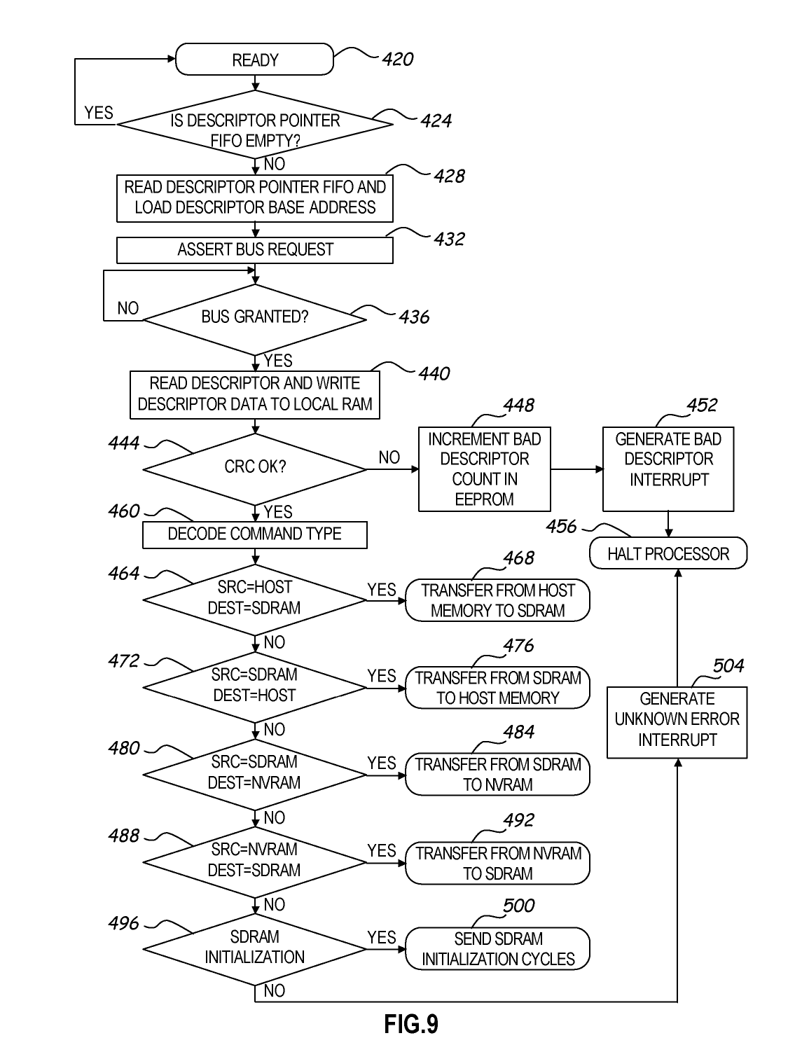

Referring now to FIG. 9, the operational steps of the backup device processor when receiving commands are now described. At block 420, the backup device is ready. At block 424, it is determined if the descriptor pointer FIFO is empty. If the descriptor pointer FIFO is empty, the operational steps associated with blocks 420 and 424 are repeated. If the descriptor pointer FIFO is not empty, the processor reads the descriptor pointer FIFO and loads the descriptor base address, as indicated at block 428. As discussed previously, in one embodiment the backup device utilizes descriptors to receive commands from the storage controller. Descriptor pointers are placed in a FIFO and the PCI base address is read to obtain the descriptor. At block 432, a bus request is asserted. In one embodiment, the processor asserts a PCI bus request. At block 436, it is determined if the bus is granted to the backup device. If the bus is not granted, the backup device continues to wait for the bus to be granted. If it is determined that the bus is granted, the descriptor is read and the descriptor data is written to the processor local RAM, as indicated at block 440.

At block 444, it is determined if the CRC is good for the descriptor data written to local RAM. If the CRC is not good, the bad descriptor count in the EEPROM is incremented, as noted at block 448. At block 452, a bad descriptor interrupt is generated, and the processor is halted at block 456. As is understood, a CRC is an error detection mechanism used in data transfer applications. The CRC is calculated on data which is transferred, and it is determined if the calculated CRC matches the CRC for the data which is generated by the device sending the data. If the CRC numbers do not match, this indicates that there is an error in the data. If, at block 444, the CRC is good, the command type is decoded, as noted at block 460.

At block 464 is it determined if the command code indicates that the source of the data is the host and the destination of the data is the SDRAM. If so, the processor performs the operational steps for transferring data from the host memory to the SDRAM, as indicated at block 468. If block 464 generates a negative result, at block 472 it is determined if the command code indicates that the source of the data is the SDRAM and the destination of the data is the host. If so, the processor performs the operational steps for transferring data from the SDRAM to the host memory, as indicated at block 476. If block 472 generates a negative result, at block 480 it is determined if the command code indicates that the source of the data is the SDRAM and the destination of the data is the NVRAM. If so, the processor performs the operational steps for transferring data from the SDRAM to the NVRAM, as indicated at block 484. If block 472 generates a negative result, at block 488 it is determined if the command code indicates that the source of the data is the NVRAM and the destination of the SDRAM. If so, the processor performs the operational steps for transferring data from the NVRAM to the SDRAM, as indicated at block 492. If block 488 generates a negative result, at block 496 it is determined if the command code indicates that the SDRAM is to be initialized. If so, the processor sends SDRAM initialization cycles, as indicated at block 500. If the command type is not a command of blocks 464, 472, 480, 488, or 496, the processor generates an unknown error interrupt, as indicated at block 504, and halts the processor, as noted at block 456. As will be understood, the order of the operational steps described with respect to FIG. 9 may be modified, and the order described is one example of the operational steps. Furthermore, one or more operational steps may be combined, and operations described may be broken into several operational steps.

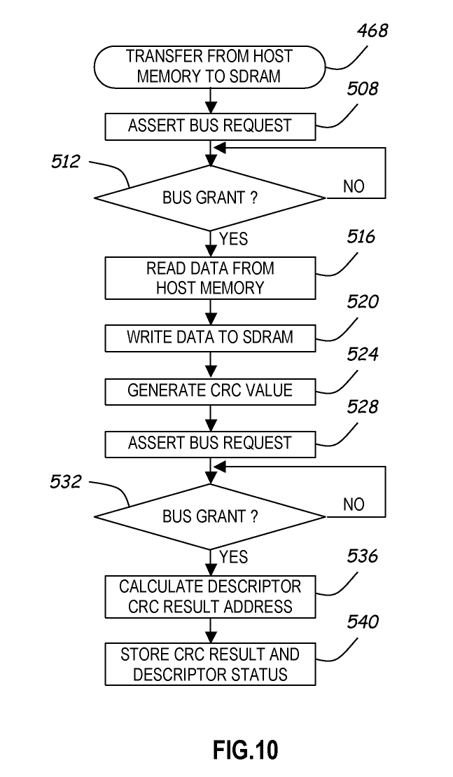

Referring now to FIG. 10, the operational steps following block 468 for transferring data from the host memory to the SDRAM are now described for an embodiment. In this embodiment, the backup device processor asserts a bus request, as noted at block 508. At block 512, the backup device processor determines if the bus has been granted. If the bus has not been granted, the backup device processor waits until the bus has been granted. At block 516, following the determination that the bus has been granted, the backup device processor reads data from the host memory. The backup device processor, at block 520, writes the data to the SDRAM. At block 524, a CRC value is generated. A bus request is asserted at block 528. It is determined, at block 532 whether the bus has been granted. If the bus has not been granted, the backup device processor waits for the bus to be granted. After it is determined that the bus has been granted, the backup device processor calculates a descriptor CRC result address, as indicated at block 536. At block 540, the backup device processor stores the CRC result and descriptor status. As will be understood, the order of the operational steps described with respect to FIG. 10 may be modified, and the order described is one example of the operational steps. Furthermore, one or more operational steps may be combined, and operations described may be broken into several operational steps.

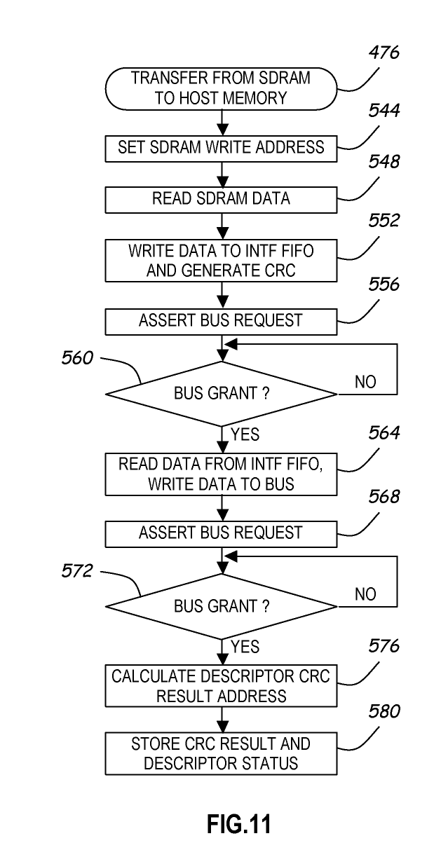

Referring now to FIG. 11, the operational steps following block 476 for transferring data from SDRAM to host memory. In this embodiment, at block 544, the backup device processor sets the SDRAM write address. The SDRAM address is the starting address at which the data within the SDRAM that is to be transferred is located. At block 548, the backup device processor reads the SDRAM data. At block 552, the backup device processor writes the data to a FIFO and generates a CRC value for the data. The FIFO stores the data for transmission over the bus. At block 556, the backup device processor asserts a bus request. At block 560, it is determined if the bus has been granted. If the bus has not been granted, the backup device processor repeats the operations of block 560 until it is determined that the bus has been granted. At block 564, after the grant of the bus, the backup device processor reads the data from the FIFO and writes the data to the bus. At block 568, the backup device processor asserts a bus request. At block 572, it is determined is the bus has been granted. If the bus has not been granted, the backup device processor waits until the bus has been granted. At block 576, following the grant of the bus, the backup device processor calculates a descriptor CRC result address. The backup device processor, at block 580, stores the CRC result and descriptor status. As will be understood, the order of the operational steps described with respect to FIG. 11 may be modified, and the order described is one example of the operational steps. Furthermore, one or more operational steps may be combined, and operations described may be broken into several operational steps.

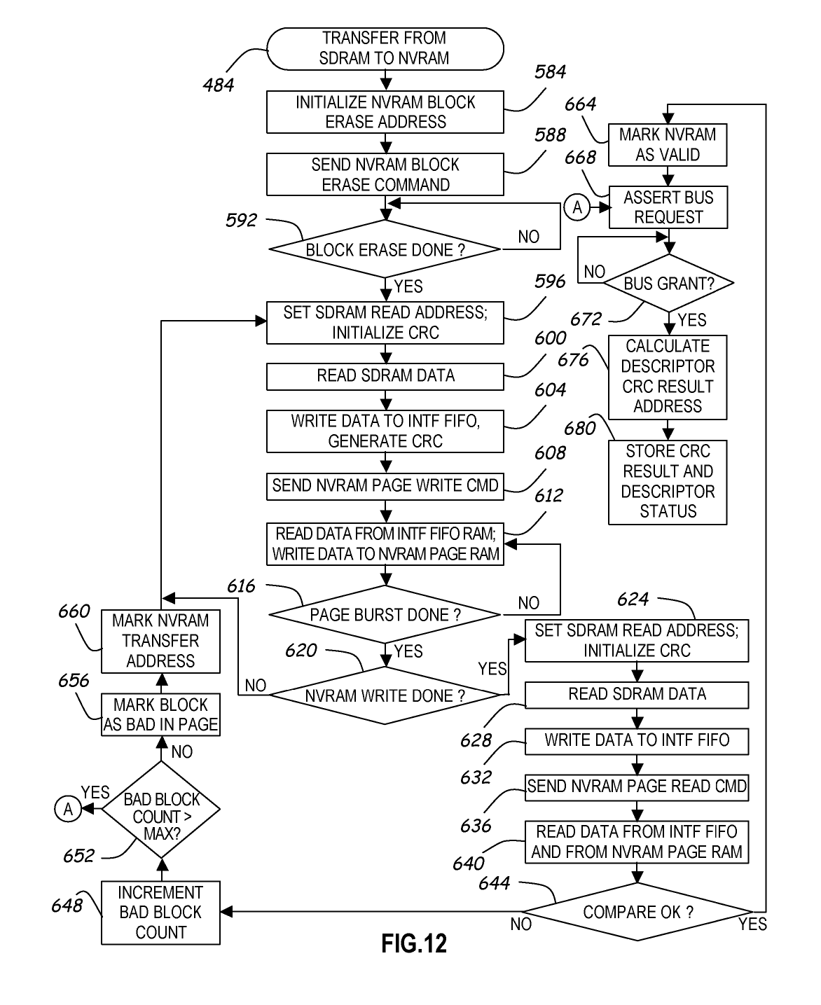

Referring now to FIG. 12, the operational steps following block 484 for transferring data from SDRAM to NVRAM. In this embodiment, at block 584, the backup device processor initializes the NVRAM block erase address. As is understood, flash memory stores data in blocks, or pages, at a time with each page containing a set amount of data. When writing a page of data, having a page address, the page is first erased and then data is written to the page. When initializing the NVRAM block erase address, the backup device processor sets the base address at which data will be written to the NVRAM. At block 588, the backup device processor sends a NVRAM block erase command. When erasing a block of data, a flash memory takes a relatively long time. At block 592, it is determined if the block erase is done. If the block erase is not done, the operation of block 592 is repeated. If the block erase is done, the backup device processor sets the SDRAM read address and initiates a CRC calculation, as indicated at block 596.

At block 600, the backup device processor reads the SDRAM data. At block 604, the backup device processor writes the data to the FIFO and generates a CRC value. The backup device processor then sends a NVRAM page write command. At block 612, the backup device processor reads the data from the FIFO and writes the data to the NVRAM page RAM. As is also understood, when writing data to a flash memory, the data is written to a page RAM within the flash memory, and the data is then moved from the page RAM to the designated flash page memory. Moving data to NVRAM page RAM is referred to as a page burst, and moving data from the NVRAM page RAM to the NVRAM page is referred to as a NVRAM write. At block 616, it is determined if the page burst is done. If the page burst is not done, the backup device processor repeats the operation associated with block 616. If it is determined that the page burst is done, the backup device processor determines if the NVRAM write is done. The NVRAM write is complete when all of the data from the SDRAM is written to the NVRAM. If the NVRAM write is not done, the backup device processor repeats the operations of block 620.

If the NVRAM write is done at block 620, the backup device processor sets the SDRAM read address, and initializes a CRC, according to block 624. The SDRAM data is then read at block 628. The data is written to the FIFO, at block 632. At block 636, the backup device processor sends an NVRAM page read command. At block 640, the backup device processor reads the data from the FIFO and from the NVRAM page RAM. The data is compared, and at block 644, it is determined if the compare is OK. If the compare is not OK, indicating that the data from the SDRAM is not the same as the data read from the NVRAM, the backup device processor increments a bad block count, as noted at block 648. At block 652, it is determined if the bad block count is greater than a predetermined maximum number of blocks. If the bad block count is not greater than the predetermined maximum, the backup device processor marks the block as bad in the NVRAM page, according to block 656. At block 660, the backup device processor updates the NVRAM transfer device, and repeats the operations associated with block 596. If, at block 644, the comparison is OK, the backup device processor marks the SDRAM as valid.

At block 668, the backup device processor asserts a bus request. Also, if the bad block count is greater than the predetermined maximum at block 652, the operations associated with block 668 are performed. At block 672, it is determined if the bus is granted. If the bus is not granted, the operation of block 672 is repeated. If the bus is granted, at block 676, the backup device processor calculates a descriptor CRC read address. At block 680, the backup device processor stores the CRC result and descriptor status. As will be understood, the order of the operational steps described with respect to FIG. 12 may be modified, and the order described is one example of the operational steps. Furthermore, one or more operational steps may be combined, and operations described may be broken into several operational steps.

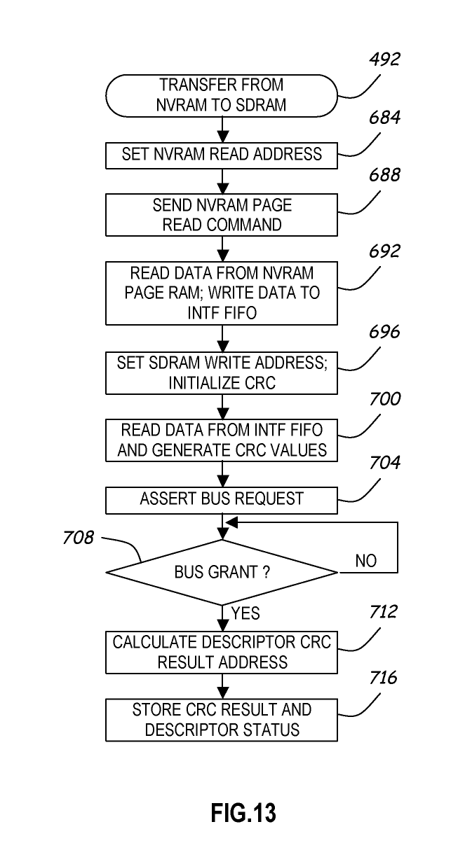

Referring now to FIG. 13, the operational steps following block 492 for transferring data from NVRAM to SDRAM. At block 684, the backup device processor sets the NVRAM read address. The backup device then, at block 688, sends a NVRAM page read command. At block 692, the backup device processor reads data from the NVRAM page RAM, and writes data to the FIFO. The SDRAM write address is set, and a CRC is initialized, at block 696. The backup device processor, at block 700, reads data from the FIFO and generates CRC values. At block 704, a bus request is asserted. It is determined, at block 708, if the bus has been granted. If the bus has not been granted, the operation of block 708 is repeated. If the bus is granted, the backup device processor calculates a descriptor CRC result address, as block 712. At block 716, the CRC result and descriptor status are stored.

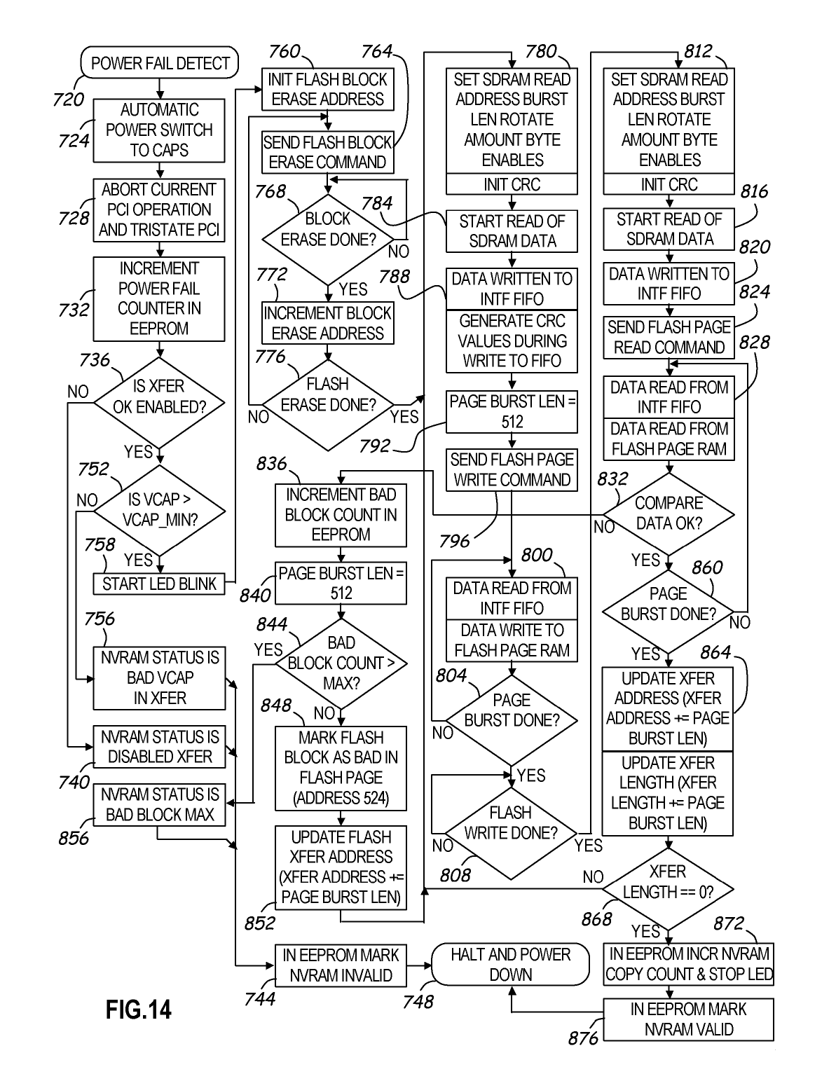

Referring now to FIG. 14, the operational steps performed by the backup device upon detection of a power failure are now described. As discussed previously, the backup device monitors the primary power supply. In the PCI card embodiment, this monitoring is performed by monitoring the voltage at a +5 volt pin. In another embodiment, the backup device monitors the PCI bus for a power failure indication. Initially, at block 720, a power failure is detected. At block 724, the backup device processor switches the power to the capacitors. At block 728, the processor aborts any current PCI operation and tristates the PCI. The power fail counted in the EEPROM is incremented, according to block 732. At block 736, it is determined if a SDRAM to NVRAM transfer is enabled. The transfer is enabled when a flag, or other indicator, is set to show that such a transfer may take place. If the transfer is not enabled, the NVRAM status is set as “disabled transfer,” as noted at block 740. At block 744, the EEPROM is marked to indicate that the NVRAM is invalid. At block 748, the backup device halts and powers down. If the transfer is enabled at block 736, it is determined at block 752 if the voltage at the capacitors is greater than a minimum voltage required to transfer data from the SDRAM to the NVRAM. The minimum voltage required is dependent upon a number of factors, including the discharge rate of the capacitors, the size of the capacitors, and the amount of power and time required for the other components within the backup device to complete the transfer. If the capacitor voltage is not greater than the minimum voltage, the status of the NVRAM is set to indicate the capacitor voltage was below the minimum in the transfer, as indicated at block 756. The operations associated with blocks 744 and 748 are then performed. If the capacitor voltage is greater than the minimum required voltage, the backup device processor starts an LED blink, as noted at block 758. The LED blink provides a visual indication that the backup device is performing a data transfer to non-volatile memory due to a power failure. As will be understood, such a feature is not a requirement for the transfer, and merely provides a visual indication that such a transfer is taking place.

At block 760, the backup device processor initializes a flash block erase address. This initialization sets the address at which the flash will begin to be erased. At block 764, the backup device processor sends a flash block erase command. At block 768, it is determined if the block erase is done. If the erase is not done, the operation associated with block 768 is repeated. If the erase is done, the backup device processor increments the block erase address, as noted at block 772. It is determined, at block 776, if the flash erase is done. If the flash erase is not done, the operations of blocks 764 through 776 are repeated. If the flash erase is done, the backup device processor sets the SDRAM read address, burst length, rotate amount, and byte enables, and initializes a CRC, as indicated at block 780. At block 784, the backup device processor starts the read of SDRAM data. At block 788, the data is written to the data FIFO, and CRC values are generated during the write to the FIFO. At block 792, the page burst length is set to 512, indicating that 512 bytes of data are included in each page when writing to the NVRAM. At block 796, the backup device processor sends a flash page write command. The data is then read from the FIFO, and written to the flash page RAM, as noted by block 800. At block 804, it is determined if the page burst is done. If the page burst is not done, the operations associated with block 800 and 804 are repeated. If the page burst is done, it is determined, at block 808, if the flash write is done. If the flash write is not done, the operation associated with block 808 is repeated. If the flash write is done, the backup device processor, at block 812, sets the SDRAM read address, burst length, rotate amount, and byte enables, and initializes a CRC. At block 816, the backup device processor starts a read of the SDRAM data. At block 820, the read SDRAM data is written to the FIFO. A flash page read command is sent, as noted by block 824. At block 828, the backup device processor reads the data from the FIFO and reads the data from the flash page RAM. At block 832, it is determined if a comparison of the data from the FIFO and the flash page RAM are the same. If the comparison indicates that the data is not the same, the backup device processor increments a bad block count in the EEPROM, at noted by block 836. At block 840, the backup device processor sets the page burst length to 512, and at block 844, it is determined if the bad block count is greater than a maximum bad block count. If the bad block count is not greater than the maximum, the backup device processor marts the flash block as bad in a designated flash page, as indicated by block 848. At block 852, the flash transfer address is updated to be the previous transfer address plus the page burst length, and the operations described beginning with block 780 are repeated. If the bad block count is greater than the maximum, as determined at block 844, the backup device processor sets the NVRAM status to indicate that the bad block maximum was reached, according to block 856. The operations of blocks 744 and 748 are then performed.

If, at block 832, the comparison indicates that the data was properly written to the flash memory, the backup device processor determined if the page burst is done, as noted by block 860. If the page burst is not done, the operations of block 828 and 832 are performed. If the page burst is done, the backup device processor updates the transfer address to be the previous transfer address plus the page burst length, and updates the transfer length to be the transfer length less the page burst length, according to block 864. The transfer length indicates the amount of data to be transferred from the SDRAM to the NVRAM. At block 868, it is determined if the transfer length is zero, indicating the transfer from SDRAM to NVRAM is complete. If the transfer length is not zero, the operations beginning at block 780 are performed. If the transfer length is zero, the backup device processor increments the NVRAM copy count in the EEPROM and stops the LED blink, as noted at block 872. At block 876, the backup device processor marks the EEPROM to indicate that the NVRAM is valid. The backup device is then halted and powered down, as noted at block 748. As will be understood, the order of the operational steps described with respect to FIG. 14 may be modified, and the order described is one example of the operational steps. Furthermore, one or more operational steps may be combined, and operations described may be broken into several operational steps.

In one embodiment, the backup device also calculates an ECC when transferring data from the SDRAM to the NVRAM. ECC is a well understood error correction mechanism used in numerous data storage and transmission applications. In this embodiment, the backup device processor generates/checks ECC across 256 bytes of data, and updates the ECC one byte at a time. For every 256 data bytes, 22 ECC bits are generated. The ECC algorithm is able to correct up to one bit error over every 256 bytes. As ECC algorithms are well understood, particular algorithms, which may be utilized to generate ECC, are not described. In one embodiment NAND flash memory is utilized as the NVRAM within the backup device. Each NAND flash chip comprises pages, each page having 528 bytes, of which bytes 0-511 are data, and 512-527 are used to store other information associated with the particular page. In this embodiment, 6 bytes of ECC are required for each page, (three bytes for each 256 bytes of data). In one embodiment, these six bytes of data are stored in bytes 512-517 of each flash page. In this embodiment, as data is written to the flash memory ECC is also generated. After the first 256 bytes of data have been sent to the flash memory, the calculated ECC is stored to be sent out at the end of the page. The remaining 256 bytes of data are sent out to the flash memory, followed by the ECC bytes. When transferring from flash memory to SDRAM, no ECC checking is performed. In this embodiment, the host, or storage controller, software processes every logical page of flash memory during a recovery from a failure. In this embodiment, the ECC from the flash memory is copied directly to the SDRAM along with the data, and the storage controller accounts for the ECC information during recovery from a failure.

While the invention has been particularly shown and described with reference to embodiments thereof, it will be understood by those skilled in the art that various other changes in the form and details may be made without departing from the spirit and scope of the invention.

What is claimed is:

1. A data storage system comprising:
a first data storage device comprising a first data storage device memory for holding data;
a second data storage device comprising:
a second data storage device volatile memory;
a second data storage device non-volatile memory; and
a processor for causing a copy of data provided to said first data storage device to be provided to said second data storage device volatile memory, and in the event of a power interruption moving said data from said second data storage device volatile memory to said second data storage device non-volatile memory.

2. The data storage system, as claimed in claim 1, wherein said first data storage device comprises at least one hard disk drive.

3. The data storage system, as claimed in claim 1, wherein said first data storage device comprises a plurality of hard disk drives.

4. The data storage system, as claimed in claim 1, wherein said first data storage device memory comprises a volatile write-back cache and a storage media capable storing said data.

5. The data storage system, as claimed in claim 4, wherein said first data storage device, upon receiving data to be stored on said storage media, stores said data in said volatile write-back cache and generates an indication that said data has been stored at said first data storage device before storing said data on said media.

6. The data storage system, as claimed in claim 1, wherein said second data storage device further comprises a secondary power source.

7. The data storage system, as claimed in claim 6, wherein said secondary power source comprises a capacitor.

8. The data storage system, as claimed in claim 6, wherein said secondary power source comprises a battery.

9. The data storage system, as claimed in claim 6, wherein said second data storage device, upon detection of a power interruption, switches to said secondary power source and receives power from said secondary power source while moving said data from said second data storage device volatile memory to said second data storage device non-volatile memory.

10. The data storage system, as claimed in claim 9, wherein upon completion of moving said data from said second data storage device volatile memory to said second data storage device non-volatile memory, said second data storage device discontinues receiving power from said secondary power source.

11. The data storage system, as claimed in claim 1, wherein said second data storage device non-volatile memory comprises an electrically erasable programmable read-only-memory.

12. The data storage system, as claimed in claim 11, wherein said second data storage device volatile memory comprises a random access memory.

13. The data storage system, as claimed in claim 1, wherein said processor, upon detection of a power interruption, reads said data from said second data storage device volatile memory, writes said data to said second data storage device non-volatile memory, and verifies that said data stored in said second data storage device non-volatile memory is correct.

14. The data storage system, as claimed in claim 13, wherein said processor verifies that said data stored in said second data storage device non-volatile memory is correct by comparing said data from said second data storage device non-volatile memory with said data from said second data storage device volatile memory, and re-writing said data to said second data storage device non-volatile memory when the comparison indicates that the data is not the same.

15. The data storage system, as claimed in claim 1, wherein said processor, upon detection of a power interruption, reads said data from said second data storage device volatile memory, computes an ECC for said data, and writes said data and said ECC to said second data storage device non-volatile memory.

16. The data storage system, as claimed in claim 1, wherein said first data storage device and said second data storage device are operably interconnected to a storage server, said storage server operable to cause data to be provided to each of said first and second data storage devices.

17. The data storage system, as claimed in claim 16, wherein said storage server comprises a storage server CPU.

18. The data storage system, as claimed in claim 17, wherein said storage server is capable of:
receiving block data to be written to said first data storage device, said block data comprising unique block addresses within said first data storage device and data to be stored at said unique block addresses;
storing said block data in said second data storage device;
manipulating said block data, based on said unique block addresses, to enhance the efficiency of said first data storage device when said first data storage device stores said block data to said first data storage device memory; and
issuing one or more write commands to said first data storage device to write said block data to said first data storage device memory.

19. The data storage system, as claimed in claim 18, wherein said manipulating said block data comprises reordering said block data based on said unique block addresses such that seek time within said first data storage device is reduced.

20. The data storage system, as claimed in claim 1, wherein said processor, following restoration of power after the power interruption, moves said data from said second data storage device non-volatile memory to said second data storage device volatile memory.

21. The data storage system, as claimed in claim 20, wherein said processor upon detection of the power restoration, reads said data from said second data storage device non-volatile memory, computes an ECC for said data, and compares said ECC to a stored ECC read from said second data storage device non-volatile memory.

22. A data storage system, comprising:
a block data storage device capable of storing block data to a first memory;
a backup memory device comprising a backup non-volatile memory; and
a block data storage processor interconnected to said block data storage device and said backup memory device, that is capable of:
receiving block data to be written to said block data storage device, said block data comprising unique block addresses within said first memory and data to be stored at said unique block addresses;
storing said block data in said backup memory device;
manipulating said block data, based on said unique block addresses, to enhance the efficiency of said block data storage device when the block data storage device stores said block data to said first memory; and
issuing one or more write commands to said block data storage device to write said block data to said first memory.

23. The data storage system, as claimed in claim 22, wherein said block data storage device memory comprises a volatile write-back cache and a storage media capable storing said data.

24. The data storage system, as claimed in claim 23, wherein said block data storage device, upon receiving data to be stored on said storage media, stores said data in said volatile write-back cache and reports to said block data storage controller that said data has been stored at said block data storage device before storing said data on said storage media.

25. The data storage system, as claimed in claim 22, wherein said backup memory device further comprises a backup volatile memory and a backup power source.

26. The data storage system, as claimed in claim 25, wherein said backup power source comprises a capacitor.

27. The data storage system, as claimed in claim 25, wherein said backup power source comprises a battery.

28. The data storage system, as claimed in claim 25, wherein said backup memory device, upon detection of a power interruption, switches to said backup power source and receives power from said backup power source and moves said data from said backup volatile memory to said backup non-volatile memory.

29. The data storage system, as claimed in claim 28, wherein said backup memory device, upon detection of a power interruption, reads said data from said backup volatile memory, writes said data to said backup non-volatile memory, and verifies that said data stored in said backup non-volatile memory is correct.

30. The data storage system, as claimed in claim 28, wherein said backup memory device, upon detection of a power interruption, reads said data from said backup volatile memory, computes an ECC for said data, and writes said data and said ECC to said backup non-volatile memory.

31. The data storage system, as claimed in claim 30, wherein said backup memory device upon detection of power restoration following the power interruption, said data is moved from said backup non-volatile memory to said backup volatile memory.

32. The data storage system, as claimed in claim 31, wherein said backup memory device reads data from said backup non-volatile memory, computes an ECC for said data, compares said computed ECC to said ECC written to said backup non-volatile memory, and writes said data to said data to said volatile memory.

33. The data storage system, as claimed in claim 31, wherein said block data storage device comprises a plurality of hard disk drives, and
wherein said block data storage processor is further capable to write an identifier to each of said hard disk drives identifying said backup memory device, and
wherein said block data storage processor verifies that said identifier is present on each of said hard disk drives following the power restoration.

34. The data storage system, as claimed in claim 22, wherein said manipulating said block data comprises reordering said block data based on said unique block addresses such that seek time within said block data storage device is reduced.

35. A method for storing data in a data storage system, comprising:
providing a first data storage device comprising a first memory for holding data;
providing a second data storage device comprising a second volatile memory and a second non-volatile memory;
storing said data to be stored at said first data storage device at said second data storage device in said second volatile memory; and
moving said data from said second volatile memory to said second non-volatile memory in the event of a power interruption.

36. The method, as claimed in claim 35, wherein said first data storage device comprises at least one hard disk drive.

37. The method, as claimed in claim 35, wherein said first data storage device memory comprises a volatile write-back cache and a storage media capable storing said data.

38. The method, as claimed in claim 37, wherein said first data storage device, upon receiving data to be stored on said storage media, stores said data in said volatile write-back cache and generates an indication that said data has been stored at said first data storage device before storing said data on said media.

39. The method, as claimed in claim 35, wherein said second data storage device further comprises a secondary power source.

40. The method, as claimed in claim 39, wherein said secondary power source comprises a capacitor.

41. The method, as claimed in claim 39, wherein said secondary power source comprises a battery.

42. The method, as claimed in claim 39, wherein said moving step comprises:
switching said second memory device to said secondary power source;
reading said data from said second data storage device volatile memory; and
writing said data to said second data storage device non-volatile memory.

43. The method, as claimed in claim 42, wherein said moving step further comprises:
switching said second memory device off of said secondary power source following said writing step.

44. The method, as claimed in claim 35, wherein said moving step comprises:
detecting a power interruption;
reading said data from said second data storage device volatile memory;
writing said data to said second data storage device non-volatile memory; and
verifying that said data stored in said second data storage device non-volatile memory is correct.

45. The method, as claimed in claim 44, wherein said verifying step comprises:
comparing said data from said second data storage device non-volatile memory with said data from said second data storage device volatile memory; and
re-writing said data to said second data storage device non-volatile memory when said comparing step indicates that the data is not the same.

46. The method, as claimed in claim 35, wherein said moving step comprises:
detecting a power interruption;
reading said data from said second data storage device volatile memory;
computing an ECC for said data; and
writing said data and said ECC to said second data storage device non-volatile memory.

47. The method, as claimed in claim 35, further comprising:
providing a block data storage controller operably interconnected to said first and second data storage devices.

48. The method, as claimed in claim 47, wherein said block data storage controller comprises an operating system and a block storage processor that is capable of:
receiving block data to be written to said first data storage device, said block data comprising unique block addresses within said first data storage device and data to be stored at said unique block addresses;
storing said block data in said second data storage device;
manipulating said block data, based on said unique block addresses, to enhance the efficiency of said first data storage device when said first data storage device stores said block data to said first data storage device memory; and
issuing one or more write commands to said first data storage device to write said block data to said first data storage device memory.

49. The method, as claimed in claim 48, wherein said manipulating said block data comprises reordering said block data based on said unique block addresses such that seek time within said first data storage device is reduced.

50. The method, as claimed in claim 35, further comprising:
detecting a power restoration after the power interruption; and
secondly moving said data from said second non-volatile memory to said second volatile memory.

51. The method, as claimed in claim 50, wherein said secondly moving step comprises:
reading said data from said second data storage device non-volatile memory;
computing an ECC for said data;
comparing said ECC to stored ECC stored at said second data storage device non-volatile memory; and
writing said data to said second data storage device volatile memory when said comparing step indicates said ECC and stored ECC are the same, and generating an error when said comparing step indicates said ECC and stored ECC are not the same.

52. The method, as claimed in claim 50, wherein said step of providing a first data storage device comprises providing a plurality of data storage devices each having an identification stored thereon identifying said second data storage device, and wherein the method further comprises:
writing said data stored at said second data storage device volatile memory to said hard disk drives when said identification is present on all of said hard disk drives, and generating an error when said identification is not present on all of said hard disk drives.

53. A data storage system comprising:
a primary data storage device comprising a primary memory for holding data;
a backup data storage device comprising:
a backup volatile memory,
a backup non-volatile memory,
a backup power source, and
a processor operable to:
cause a copy of data provided to said primary data storage device to be provided to said backup volatile memory; and
upon detection of a power interruption, move said data from said backup volatile memory to said backup non-volatile memory and verify the accuracy of the data stored in said backup non-volatile memory using power supplied by said backup power source.

54. The data storage system, as claimed in claim 53, wherein said primary data storage device comprises at least one hard disk drive.

55. The data storage system, as claimed in claim 53, wherein said primary data storage device memory comprises a volatile write-back cache and a storage media capable storing said data.

56. The data storage system, as claimed in claim 55, wherein said primary data storage device, upon receiving data to be stored on said storage media, stores said data in said volatile write-back cache and generates an indication that said data has been stored at said primary data storage device before storing said data on said media.

57. The data storage system, as claimed in claim 53, wherein said backup power source comprises a capacitor.

58. The data storage system, as claimed in claim 53, wherein said backup data storage device non-volatile memory comprises an electrically erasable programmable read-only-memory, and said backup data storage device volatile memory comprises a random access memory.

59. The data storage device, as claimed in claim 53, wherein said processor verifies that said data stored in said backup data storage device non-volatile memory is correct by comparing said data from said backup data storage device non-volatile memory with said data from said backup data storage device volatile memory, and re-writing said data to said backup data storage device non-volatile memory when the comparison indicates that the data is not the same.

60. The data storage system, as claimed in claim 53, wherein said processor, upon detection of a power interruption, reads said data from said backup data storage device volatile memory, computes an ECC for said data, and writes said data and said ECC to said backup data storage device non-volatile memory.

61. The data storage system, as claimed in claim 53, wherein said primary data storage device and said backup data storage device are operably interconnected to a block data storage server, said storage server operable to cause data to be provided to each of said primary and backup data storage devices.

62. The data storage device, as claimed in claim 61, wherein said block data storage server comprises an operating system and a block storage processor that is capable of:
receiving block data to be written to said primary data storage device, said block data comprising unique block addresses within said primary data storage device and data to be stored at said unique block addresses;
storing said block data in said second data storage device;
manipulating said block data, based on said unique block addresses, to enhance the efficiency of said primary data storage device when said primary data storage device stores said block data to said primary data storage device memory; and
issuing one or more write commands to said primary data storage device to write said block data to said primary data storage device memory.

63. The data storage device, as claimed in claim 62, wherein said manipulating said block data comprises reordering said block data based on said unique block addresses such that seek time within said primary data storage device is reduced.
